(19) United States
(12) Patent Application Publication
(10) Pub. No.: US 2025/0295102 A1
(43) Pub. Date: Sep. 25, 2025

(54) AGRICULTURAL LOCALIZED SPRAYING SYSTEM WITH INTEGRATED ILLUMINATION SOURCE

(71) Applicant: EXCEL INDUSTRIES, EPERNAY (FR)

(72) Inventors: Matthieu HEMMERLE, EPERNAY (FR); Colin CHABALLIER, CHALONS EN CHAMPAGNE (FR)

(73) Assignee: EXCEL INDUSTRIES, EPERNAY (FR)

(21) Appl. No.: 18/692,134

(22) PCT Filed: Oct. 27, 2021
(86) PCT No.: PCT/FR2021/051886

§ 371 Date: Oct. 28, 2024

(30) Foreign Application Priority Data
Sep. 16, 2021 (FR) FR2109744

(51) Int. Cl. A01M 7/00

(52) U.S. Cl. CPC A01M 7/0089; A01M 7/0042

(57) ABSTRACT

The invention belongs to the field of agricultural spot-spraying using an agricultural machine. The invention relates to a spot-spraying system. According to the invention, the spraying system comprises: # a plurality of spraying sections arranged to spray the treatment product onto areas of a plot: # an optical head comprising a camera generating a sequence of images at acquisition times (t_{acq}) and a light source emitting a beam of light in the direction of the plot with a variable light intensity: # a spraying control unit configured to process the images of the sequence at processing times (tₜᵣₐᵢₜ) and to control the spraying sections individually according to the image processing; and # a light control unit arranged to determine the light intensity of the light beam to be emitted by the light source at each processing time (tₜᵣₐᵢₜ), said light intensity being determined according to an image of the sequence of images taken at an acquisition time preceding the processing time in question.

### TECHNICAL FIELD

The invention is in the field of agricultural spraying and, more precisely, localized spraying using an agricultural machine as a function of data captured in real time by one or more on-board cameras. It relates to a localized spraying system.

### PRIOR ART

The purpose of agricultural spraying is to apply different treatment products to crops, generally aiming to optimize their growth, yield and/or quality. The treatment products may notably be used to weed, combat disease, insect or parasite infestation, and provide the nutrients required for proper crop development.

A spraying system comprises, conventionally, a tank arranged to contain a treatment product, possibly diluted, a spray boom comprising a plurality of spray nozzles, and a hydraulic circuit connecting the tank to the different spray sections. The spray boom generally extends along a transversal axis relative to a longitudinal direction along which the agricultural machine travels over the plot. The hydraulic circuit may notably comprise a pump arranged to suck the treatment product into the tank and convey it to the spray boom, and a pressure regulator arranged to maintain the pressure in the hydraulic circuit at a predetermined threshold pressure. Each spray nozzle is arranged to spray the treatment product over a predetermined width of the plot defined along the transversal axis.

With the objective of reducing the use of treatment products, spraying systems have been adapted in order to enable localized treatment of plots. Localized treatment is taken to mean spraying the product only on areas of the plot that actually require treatment. To this end, the spray boom is cut into several sections and each spray section is equipped with one or more spray nozzles and a dispenser arranged to take an open position, in which a circulation of the product is possible from the tank to each of the corresponding spray nozzles, and a closed position, in which said circulation is blocked. The dispensers of the different sections may be controlled individually. The spraying system further comprises an image acquisition system and a control unit. The image acquisition system is mounted on the agricultural machine and comprises at least one camera arranged to acquire images of the plot several tens or hundreds of milliseconds before the passage of the spraying system. Generally, it comprises a plurality of cameras distributed along a second transversal axis relative to the longitudinal direction, so as to cover the entire width likely to be treated by the spraying system. The control unit is configured to determine effective areas to be treated using image processing performed in real time on the images acquired by the image acquisition system, and to control each of the dispensers individually according to the effective areas to be treated.

For an efficient processing of the images acquired by the cameras, and thus a suitable spraying of the plot, the images must be of good quality. In particular, they must have a low noise level and correct exposure. In practice, this usually implies illuminating the scene to be imaged. A supply of light is of course indispensable when the spraying is carried out at night. It may also be desirable in the event of low light conditions, or in the presence of shadowy areas, notably at sunrise and sunset, and under clouds. One solution to illuminate the entire scene imaged by the different cameras consists in installing spotlights on the spray boom.

In order to avoid the formation of shadows along distinct axes of the viewing axis of each camera, a spotlight may be associated with each camera and arranged so as to form a light beam, the main axis of propagation of which is as close as possible to the viewing axis of the camera. However, by construction, the axis of the light beam and the viewing axis of the camera cannot be merged exactly. In so far as the spotlights are relatively close to the illuminated scene, this axial shift causes shadowy areas to appear in the images. This leads to difficulties for the image processing.

Furthermore, the conditions for illuminating the plot are likely to change over time and space. Different areas of a given plot may indeed be illuminated differently depending on the presence of trees, buildings or clouds between the sun and the considered areas of the plot. The lighting conditions may also vary rapidly with the movement of the clouds.

One aim of the invention is therefore to propose a solution for acquiring images of the plot with a homogeneous and constant illumination, so as to enable robust processing of these images for the determination of the areas to be treated of the plot. This solution must have design, manufacturing and maintenance costs that are compatible with use on an industrial scale.

### PRESENTATION OF THE INVENTION

To this end, the invention relies on the use of a light source with variable intensity for each camera. The intensity of the light beam emitted by the light source is adapted in real time to the lighting conditions of the area of the plot imaged by the camera associated with this light source.

More precisely, the subject matter of the invention is a localized spraying system carried by an agricultural machine, comprising:
a tank arranged to contain a treatment product,
a hydraulic circuit,
a spray ramp comprising a plurality of spray sections each connected to the tank by the hydraulic circuit, each spray section being equipped with a dispenser and one or more spray nozzles, each dispenser being arranged to take an open position, in which a circulation of the product is possible from the tank to each of the corresponding spray nozzles, and a closed position, in which said circulation is blocked, each spray nozzle being arranged to spray the treatment product on an area of the plot,
an optical head comprising a camera and an illumination source, the camera being arranged to generate a sequence of images of the plot at acquisition times separated two by two by a predetermined acquisition period, the light source being arranged to emit a light beam in the direction of the plot with a variable light intensity,
a spray control unit configured to process a subset of the sequence of images and individually control the spray sections as a function of the processing of the subset of images, the images of the subset being considered at processing times separated two by two by a predetermined processing period, the processing period being equal to P times the acquisition period, with P an integer greater than or equal to two, and
an illumination control unit arranged to determine the light intensity of the light beam to be emitted by the illumination source at each processing time, said light intensity for a given processing time being determined as a function of at least one image of the sequence of images taken at an acquisition time comprised between the considered processing time and the previous processing time.

The spray control unit is configured to control each spray section individually as a function of the received images associated with this spray section. It may notably implement an image processing algorithm making it possible to determine whether the area of a plot covered by a spray section requires the application of the treatment product.

According to the invention, the illumination control unit makes it possible, at the times of acquisition of the images used to control the spray sections, to illuminate the imaged area of the plot with a light stream adapted to the ambient illumination conditions.

According to one particular embodiment, the spraying system comprises a plurality of optical heads. Each optical head comprises a camera and an illumination source. Each camera is arranged to generate a sequence of images of the plot at acquisition times separated two by two by a predetermined acquisition period, and each illumination source is arranged to emit a light beam in the direction of the plot with a variable light intensity. The spray control unit is configured to process, for each optical head, a subset of the sequence of images generated by its camera and to individually control the spray sections as a function of the processing of the subset of images, the images of the subset being considered at processing times separated two by two by a predetermined processing period, the processing period being equal to P times the acquisition period, where P is an integer greater than or equal to two. The illumination control unit is arranged to determine, for each optical head, the light intensity of the light beam to be emitted by the illumination source at each processing time, said light intensity for a given processing time being determined as a function of at least one image of the sequence of images taken by the camera of the optical head considered at an acquisition time comprised between the processing time considered and the previous processing time.

The optical heads may be mounted on the spray boom or on another boom extending transversely relative to the axis of movement of the agricultural machine. Preferably, they are distributed so as to cover transversely the entire area covered by the spray nozzles.

It should be noted that the number of optical heads does not necessarily correspond to the number of spray sections of the spray ramp. The spraying system may comprise a number of optical heads less than the number of spray sections when the transversal extent of each area covered by a camera is greater than the transversal extent of the area covered by a spray section. Conversely, the spraying system may comprise a number of optical heads greater than the number of spray sections when the transversal extent of each area covered by a camera is less than the transversal extent of the area covered by a spray section.

The light intensity to be emitted by the illumination source of each optical head is for example determined, for a given processing time, as a function of the image of the sequence generated at the acquisition time immediately preceding this given processing time. In another embodiment, the light intensity is determined as a function of several images generated between the given processing time and the previous processing time. In particular, it is possible to take into account multiple images, with a higher weighting for newer images than for older images.

Preferably, the acquisition times are identical for all the cameras of the different optical heads. Thus, despite the continuous movement of the agricultural machine during the acquisition of images, it is possible to easily reconstruct a sequence of continuous images over the entire transversal area of the spray boom. The processing unit may then be arranged to process globally each image considered at a processing time.

In another embodiment, the processing unit is arranged to process in parallel the images generated by the cameras of the different optical heads.

Preferably, the camera and the light source of each optical head are grouped in a single housing. The lighting conditions may then be adapted locally for each camera.

According to one particular embodiment, the illumination control unit is arranged to determine, for each optical head, the light intensity of the light beam to be emitted by its illumination source at each acquisition time, said light intensity for a given acquisition moment being determined as a function of at least one image of the sequence of images taken at a previous acquisition time by the camera of the optical head considered. In other words, the light intensity is no longer only adjusted to the processing times at which the images used for controlling the spray sections are generated, but to all acquisition times. This embodiment has the advantage of making the light intensity emitted by each illumination source converge more quickly to the desired light intensity. The light intensity for a given acquisition time is preferably determined as a function of the image of the sequence taken at the previous acquisition time.

Still according to one particular embodiment, compatible with the previous one, the illumination control unit is composed of a plurality of illumination control sub-units. Each illumination control sub-unit is integrated into an optical head and is arranged to determine the light intensity of the light beam to be emitted by the illumination source of the respective optical head as a function of at least one image generated by the camera of the respective optical head. The light intensity may be determined for each processing time or for each acquisition time, as indicated previously.

The illumination control unit may notably be arranged to determine, for each optical head, the light intensity of the light beam to be emitted by its illumination source, as a function of a histogram of the light intensity levels of the pixels of the image or the images considered. Histogram of the light intensity levels of an image is taken to mean a discrete function that associates each light intensity value with the number of pixels taking that value. In particular, the light intensity of the light beam to be emitted may be increased when the histogram reveals underexposure, and decreased when the histogram reveals overexposure.

According to one particular embodiment, in each optical head, the camera comprises a lens arranged to capture a light stream from the plot along an optical axis and a first optical sensor arranged to receive the light stream and generate a first sequence of images of the plot, and the illumination source comprises a first set of M light sources, with M an integer greater than or equal to two, the light sources being distributed around the optical axis of the lens.

In each optical head, the first optical sensor may notably be arranged to generate the first sequence of images of the plot in one or more first acquisition spectral bands, and the first set of M light sources may then be arranged to emit a first light beam in one or more first illumination spectral bands, said one or more first illumination spectral bands covering the one or more first acquisition spectral bands.

The first acquisition spectral band(s) may cover at least partially the visible spectrum, i.e. the wavelength band comprised between 380 nm and 750 nm. By way of example, the first optical sensor is an RGB sensor, i.e. it comprises a sensitive array formed of pixels each comprising at least one subpixel sensitive to red wavelengths, at least one subpixel sensitive to green wavelengths, and at least one subpixel sensitive to blue wavelengths. The first illumination spectral band(s) cover the first acquisition spectral band(s), so as to ensure efficient illumination for the first optical sensor.

According to one particular embodiment, in each optical head, the camera further comprises a second optical sensor arranged to receive the light stream captured by the lens and generate a second sequence of images of the plot in one or more second acquisition spectral bands, and the illumination source comprises a second set of N light sources, with N an integer greater than or equal to two. The second set of N light sources is arranged to emit a second light beam in one or more second illumination spectral bands, said one or more second illumination spectral bands covering the one or more second acquisition spectral bands. The light sources of the second set are distributed around the optical axis of the lens.

The second optical sensor may be an infrared sensor. In particular, the second acquisition spectral band(s) may at least partially cover the near infrared spectrum, i.e. the wavelength band comprised between 750 nm and 900 nm.

Each optical head may comprise a dichroic filter arranged to reflect the light stream in the first acquisition spectral band(s) and transmit said light stream into the second acquisition spectral band(s). The optical sensors of each optical head may thus receive a light stream along a same viewing axis, in this case the optical axis of the lens. This makes image processing easier.

The number M of light sources of the first set is for example equal to 3, 6, 10, 12, 24 or 48. Similarly, the number N of light sources of the second set is for example equal to 3, 6, 10, 12, 24 or 48.

Advantageously, in each optical head, the light sources of the first set are arranged to form a uniform illumination of the area of the plot imaged by the camera. Still advantageously, the light sources of the second set are arranged to form a uniform illumination of the area of the plot imaged by the camera. Uniform illumination is taken to mean an illumination such that each point of the imaged area receives the same amount of light.

According to a first embodiment, in each optical head, the light sources of the first set are angularly distributed in a uniform manner around the optical axis of the lens. In other words, two adjacent light sources of the first set are spaced apart by an angle of 360/M degrees around the optical axis of the lens. Similarly, the light sources of the second set may be angularly distributed in a uniform manner around the optical axis of the lens. In other words, two adjacent light sources of the second set are spaced apart by an angle of 360/N degrees around the optical axis of the lens.

According to a second embodiment, the light sources of the first set are angularly distributed around the optical axis of the lens so as to form a uniform illumination of the area of the plot imaged by the camera. Similarly, the light sources of the second set may be angularly distributed around the optical axis of the lens so as to form a uniform illumination of the area of the plot imaged by the camera. In particular, it should be noted that when the optical head is tilted towards the ground, the more a light source is arranged on top of the optical head, the more it illuminates a large surface area. To compensate for this effect, the light sources of a set may be distributed with an angular deviation increasing from the highest light source to the lowest light source.

In each optical head, the light sources of each set may be arranged in a ring around the optical axis of the lens. In each ring, the light sources may be arranged at the same distance from the optical axis of the lens or be arranged within a predetermined range of distances. Preferably, each ring is centered on the optical axis. When the light sources of a set are angularly distributed in a uniform manner, the barycenter of the light sources of the considered set is situated on the optical axis of the lens. By way of example, the light sources of the first set form a first ring and the light sources of the second set form a second ring, the lens and the two rings being concentric.

According to one particular embodiment, in each optical head, the light sources of the first set are arranged so that each point of the imaged area receives light from at least two light sources of the first set. Similarly, the light sources of the second set may be arranged such that each point of the imaged area receives light from at least two light sources of the second set.

Still according to one particular embodiment, in each optical head, each source of light of the first set is arranged so that a main axis of its light beam is parallel to the optical axis of the lens. Similarly, each light source of the second set may be arranged so that a main axis of its light beam is parallel to the optical axis of the lens.

The subject matter of the invention is also an optical head for a localized spraying system carried by an agricultural machine. The optical head comprises a camera and an illumination source, the camera being arranged to generate a sequence of images of the plot, and the illumination source being arranged to emit a light beam in the direction of the plot with a variable light intensity.

The camera and illumination source are preferably integrated within a same housing.

According to one particular embodiment, the camera of the optical head comprises a lens arranged to capture a light stream from the plot along an optical axis and a first optical sensor arranged to receive the light stream and generate a first sequence of images of the plot. The light source may comprise a first set of M light sources, where M is an integer greater than or equal to two, the light sources being distributed around the optical axis of the lens.

The first optical sensor may notably be arranged to generate the first sequence of images of the plot in one or more first acquisition spectral bands, and the first set of M light sources may then be arranged to emit a first light beam in one or more first illumination spectral bands, said one or more first illumination spectral bands covering the one or more first acquisition spectral bands.

Still according to one particular embodiment, the camera of the optical head further comprises a second optical sensor arranged to receive the light stream captured by the lens and generate images of the plot in one or more second acquisition spectral bands, and the illumination source comprises a second set of N light sources, with N an integer greater than or equal to two. The second set of N light sources is arranged to emit a second light beam in one or more second illumination spectral bands, said one or more second illumination spectral bands covering the one or more second acquisition spectral bands. The light sources of the second set are distributed around the optical axis of the lens.

The optical head may also comprise an illumination control sub-unit arranged to determine the light intensity of the light beam to be emitted by its illumination source as a function of at least one image generated by the camera.

The various embodiments described above in connection with the optical head(s) of the spraying system described above are applicable to the optical head considered alone.

### BRIEF DESCRIPTION OF THE DRAWINGS

Other characteristics, details and advantages of the invention will become clear from reading the following description, given only by way of example, and by referring to the appended drawings in which:

FIG. 1 represents, in a perspective view, an example of an optical head according to the invention for a localized spraying system;

FIG. 2 schematically represents an arrangement of certain components of the optical head of FIG. 1;

FIG. 3 schematically represents an agricultural machine equipped with a localized spraying system according to the invention;

FIG. 4 illustrates, by means of chronograms, an example of the chronology of image acquisition and processing of these images to adjust the light intensity of the illumination source of each optical head and determine the areas of the plot to be treated.

### DETAILLED DESCRIPTION

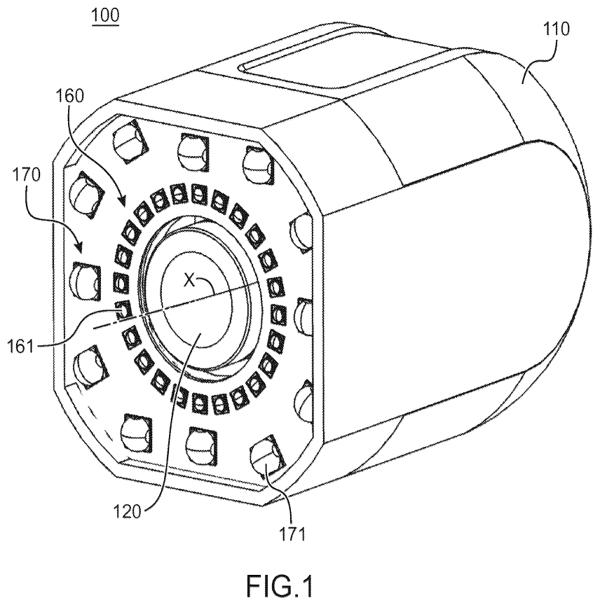

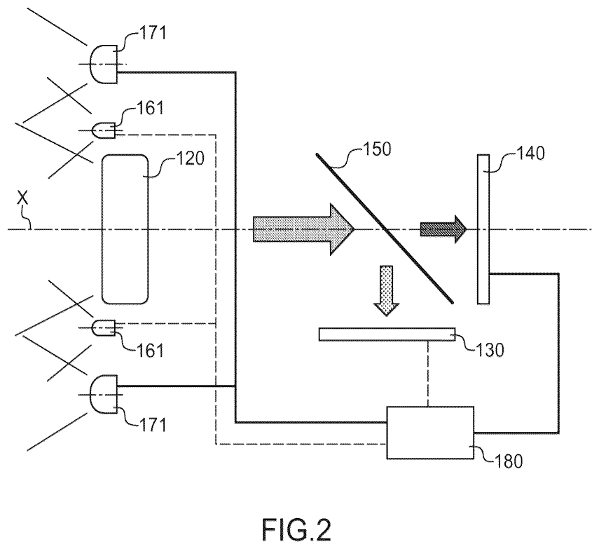

FIG. 1 represents, in a perspective view, an example of an optical head according to the invention intended to equip a localized spraying system and FIG. 2 represents, in a schematic manner, the arrangement of some of its components. The spraying system is carried by an agricultural machine, for example a tractor or a trailer. The optical head 100 comprises a housing 110 within which are housed a lens 120, a first optical sensor 130, a second optical sensor 140, a dichroic mirror 150, a first set 160 of light sources 161, a second set 170 of light sources 171 and an illumination control sub-unit 180. The optical sensors 130, 140, the dichroic mirror 150 and the illumination control sub-unit 180 are visible only in FIG. 2.

The lens 120 is arranged to capture a light stream from an area of the plot along an optical axis X and focus it on the optical sensors 130, 140. The optical axis X defines the viewing axis for the two optical sensors 130 and 140. Typically, the optical head is mounted on a spray boom and oriented downwards, i.e. under a horizontal plane.

The first optical sensor 130 is arranged to receive a portion of the light stream having passed through the lens 120 and generate a first sequence of images in three first acquisition spectral bands situated within the visible spectrum, for example RGB bands. The second optical sensor 140 is, for its part, arranged to receive another part of the light stream having passed through the lens 120 and generate a second sequence of images in a second acquisition spectral band situated within the near infrared spectrum. The images of each sequence are generated at acquisition times t_{acq} separated two by two by a predetermined acquisition period Δ_{acq}. Preferably, the acquisition times are identical for the two sequences of images. The acquisition period makes it possible to define an acquisition frequency. The acquisition frequency is for example equal to 40 Hz. The dichroic mirror 150 makes it possible to separate the light stream as a function of the wavelengths. In this case, the dichroic mirror 150 reflects the portion of the light stream of which the wavelengths are situated in the first acquisition spectral bands, and transmits the portion of the light stream of which the wavelengths are situated in the second acquisition spectral band.

The first set 160 comprises 24 light sources 161 distributed in a ring around the lens 120. Similarly, the second set 170 comprises 12 light sources 171 distributed in a ring around the lens 120, at a greater distance from the optical axis X than the light sources 161. In FIG. 2, only two light sources 161 and two light sources 171 are represented. The light sources 161 and 171 are angularly distributed in a uniform manner. The light sources 161 are arranged to each emit a light beam along a main axis of propagation parallel to the optical axis X, so as to globally form a first light beam. This first light beam is situated in a first illumination spectral band covering the three first acquisition spectral bands. The light sources 171 are arranged to each emit a light beam along a main axis of propagation parallel to the optical axis X, so as to form a second light beam. This second light beam is situated in a second illumination spectral band covering the second acquisition spectral band. Thus, the light sources 161 generate a uniform illumination suitable for the first optical sensor 130 and the light sources 171 generate a uniform illumination suitable for the second optical sensor 140. Further, due to the annular arrangement of each set 160, 170, the first and second light beams each have a main axis of propagation merged with the optical axis X. Consequently, the images generated by each optical sensor 130, 140 are devoid of shadowy areas, in particular shadows usually observed by a point light source. The light sources 161, 171 are for example light emitting diodes. According to the invention, the first set 160 makes it possible to form a first light beam of variable light intensity and the second set 170 makes it possible to form a second light beam of variable light intensity.

The light intensities of the light beams are modified by the illumination control sub-unit 180. The illumination control sub-unit 180 is arranged to receive in real time the first sequence of images generated by the first optical sensor 130 and the second sequence of images generated by the second optical sensor 140, and to determine the light intensities of the first and second light beams to be emitted at each acquisition time t_{acq}. The light intensity of the first light beam to be emitted at each given acquisition time t_{acq} is for example determined as a function of the image of the first sequence taken at the previous acquisition time. More particularly, this light intensity may be determined as a function of a histogram of the light intensity levels of the pixels of the previous image. Similarly, the light intensity of the second light beam to be emitted at each acquisition time t_{acq} is for example determined as a function of the image of the second sequence taken at the previous acquisition time, notably a histogram of the light intensity levels of its pixels. The light intensity to be emitted by each set 160, 170 may be determined directly using the sum of the light intensity levels of the histogram and a correspondence table. In another embodiment, the light intensity is increased when the histogram is representative of underexposure, and decreased when the histogram is representative of overexposure. Furthermore, as explained below, the light intensity of the first and second beams is not necessarily determined for each acquisition time. It may be determined only for the times at which the images used for the identification of the areas to be treated are taken.

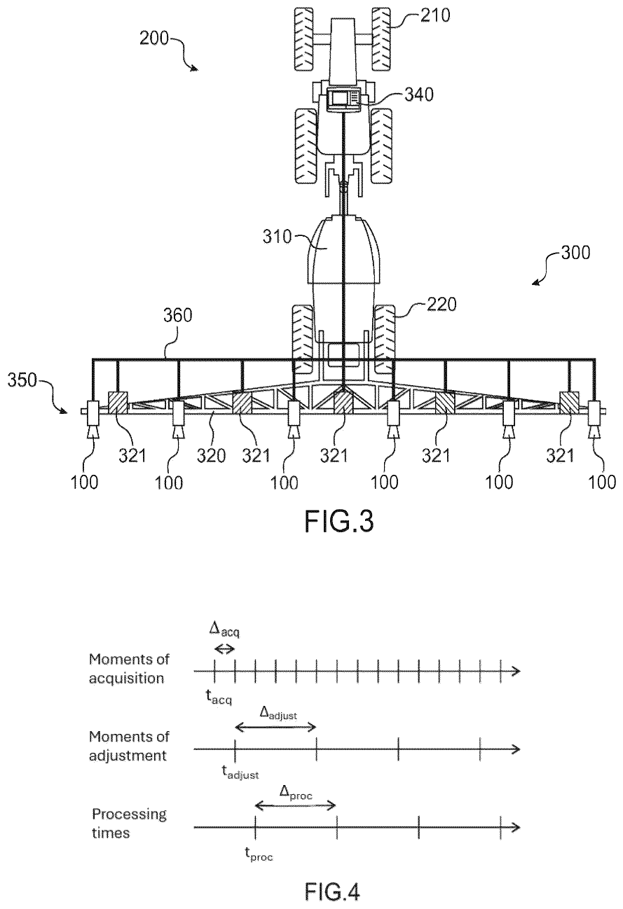

FIG. 3 schematically represents an agricultural machine equipped with a localized spraying system according to the invention. The agricultural machine 200 comprises a tractor 210 and a trailer 220. The localized spraying system 300 comprises a tank 310, a spray boom 320, a hydraulic circuit, not represented, a spray control unit 340, an image acquisition system 350, and a communication network 360. The trailer 220 carries the tank 310, the hydraulic circuit, the spray boom 320 and the image acquisition system 350. In another embodiment, the tractor 210 could carry all of the elements of the spraying system 300.

The tank 310 is arranged to contain a treatment product to be sprayed on the areas to be treated of a plot. The treatment product is, for example, a biostimulation product, for example a fertilizer or a product making it possible to stimulate the natural defenses of the cultivated plant, or a biocontrol product, for example a herbicide, an insecticide or a fungicide.

The spray boom 320 extends along a transversal axis, orthogonal to an axis of advancement of the agricultural machine 200, and comprises a plurality of spray sections 321. In the example in FIG. 3, five spray sections are represented. Nevertheless, the spray ramp may comprise a much higher number of spray sections, for example several dozens. Each spray section 321 is individually connected to the tank 310 by the hydraulic circuit and comprises a dispenser and a spray nozzle. Each dispenser is connected to the spray control unit 340 via the communication network 360 and is controlled by this unit between at least one open position, in which a circulation of the treatment product is possible from the tank 310 to the corresponding spray nozzle, and a closed position, in which said circulation is blocked. Each spray nozzle is arranged to spray the treatment product onto an area of the plot. In particular, it is arranged to spray the treatment product over a predetermined width, defined along the transversal axis.

The image acquisition system 350 comprises a plurality of optical heads 100 as defined in reference to FIGS. 1 and 2. Each optical head 100 is connected to the spray control unit 340 via the communication network 360, so as to transfer all or parts of the acquired images to it. The optical heads 100 are mounted on the spray ramp 320 and are arranged so as to acquire images of contiguous areas of the plot. The imaged areas must be located upstream of the spray nozzles, so as to enable a processing of the images by the spray control unit before the passage of the spray nozzles. It should be noted that the optical heads 100 could be mounted on a boom distinct from the spray boom 320, for example at the front of the tractor 210.

It should be noted that, in the exemplary embodiment considered above, each optical head 100 integrates an illumination control sub-unit 180 adjusting the light intensities of its sets 160, 170 of light sources. These adjustments are thus made locally in each optical head. However, the illumination control sub-units 180 of the different optical heads may be considered collectively as forming an illumination control unit. In another embodiment, the functions of the different sub-units may be grouped into a single hardware entity, also called an illumination control unit. Furthermore, the localized spraying system may comprise a central control interface making it possible to control the illumination control unit in an on mode, in which the illumination sources are switched on and their light intensity adjusted according to the invention, and an off mode, in which the illumination sources remain off.

The spray control unit 340 is arranged to determine, on the basis of the images acquired by the optical heads, whether an input of treatment product is required for the imaged areas. According to a particularity of the invention, not all the images acquired by the optical sensor(s) are used to determine the areas to be treated. The images are for example used at a processing frequency of 10 Hz, which is generally sufficient to ensure continuity between the images along the axis of advancement. The calculation load is then reduced compared to taking into account all the images of the sequence, for example at the acquisition frequency of 40 Hz. The analysis of the images may be based on different image processing algorithms. It may notably analyze the shape of plants and their spectral properties (scene reflectance). When the treatment product must be applied locally, the spray control unit 340 then controls the dispenser corresponding to the area to be treated in the open position, such that the corresponding spray nozzle delivers the treatment product. On the other hand, when the application of treatment product is not required for an area covered by a spray nozzle, the spray control unit 340 controls the corresponding dispenser in the closed position.

FIG. 4 illustrates, by means of chronograms, an example of the chronology for the acquisition of the images and their processing with a view, on the one hand, to adjust the light intensity or intensities of the illumination sources and, on the other hand, to determine the areas of the plot to be treated. A first chronogram represents the acquisition times t_{acq} of the images of the sequence(s) generated in the different optical heads. As mentioned previously, these acquisition times are preferably synchronized for all the optical heads. The successive acquisition times t_{acq} are separated by an acquisition period Δ_{acq} equal to 25 ms for an acquisition frequency of 40 Hz. A second chronogram represents the adjustment times t_{adjust} at which the images are used to adjust the light intensities. These adjustment times t_{adjust} are separated by an adjustment period Δ_{adjust} equal to 100 ms, corresponding to four times the acquisition period Δ_{acq}. A third chronogram represents the processing times t_{proc} at which the images are used to determine the areas of the plot to be sprayed. These processing times t_{proc} are separated by a processing period Δ_{proc} equal to 100 ms, corresponding to four times the acquisition period Δ_{acq}. The chronograms of FIG. 4 illustrate the fact that, for each given processing time t_{proc}, corresponding to an acquisition time t_{acq}, the light intensity or intensities to be emitted by the illumination sources are determined from the images acquired at the adjustment time t_{adjust} corresponding to the previous acquisition time. Thus, in this exemplary embodiment, the light intensities are determined with the same frequency as the processing frequency. However, in another embodiment, not represented, the light intensities of the illumination sources may be determined at the image acquisition frequency. Consequently, at each acquisition of an image in an optical head, the light intensity of its illumination source is adjusted on the basis of the image acquired at the previous acquisition time.

Generally, the light intensity of an illumination source may be adjusted by the illumination intensity of each light source, the cyclic ratio between the illumination time and the sum of the illumination and non-illumination times, and/or the ratio of the number of light sources switched on compared to the total number of light sources.

1. Localized spraying system carried by an agricultural machine, comprising:
a tank (310) arranged to contain a treatment product,
a hydraulic circuit,
a spray ramp (320) comprising a plurality of spray sections (321) each connected to the tank by the hydraulic circuit, each spray section being equipped with a dispenser and one or more spray nozzles, each dispenser being arranged to take an open position, in which circulation of the product is possible from the tank to each of the corresponding spray nozzles, and a closed position, in which said circulation is blocked, each spray nozzle being arranged to spray the treatment product on an area of the plot,
an optical head (100) comprising a camera and an illumination source, the camera being arranged to generate a sequence of images of the plot at acquisition times (t_{acq}) separated two by two by a predetermined acquisition period (Δ_{acq}), the illumination source being arranged to emit a light beam in the direction of the plot with a variable light intensity,
a spray control unit (340) configured to process a sub-set of the sequence of images and individually control the spray sections (321) as a function of the processing of the sub-set of images, the images of the sub-set being considered at processing times (t_{proc}) separated two by two by a predetermined processing period (Δ_{proc}), the processing period being equal to P times the acquisition period, where P is an integer greater than or equal to two, and
an illumination control unit (180) arranged to determine the light intensity of the light beam to be emitted by the illumination source at each processing time (t_{proc}), said light intensity for a given processing time being determined as a function of at least one image of the sequence of images taken at an acquisition time (t_{acq}) comprised between the considered processing time and the previous processing time.

2. Localized spraying system according to claim 1, comprising a plurality of optical heads (100), each optical head comprising a camera and an illumination source, each camera being arranged to generate a sequence of images of the plot at acquisition times (t_{acq}) separated two by two by a predetermined acquisition period (Δ_{acq}), each illumination source being arranged to emit a light beam in the direction of the plot with a variable light intensity,
the spray control unit (340) being configured to process, for each optical head (100), a subset of the sequence of images generated by its camera and individually control the spray sections (321) as a function of the processing of the subset of images, the images of the subset being considered at processing times (t_{proc}) separated two by two by a predetermined processing period (Δ_{proc}), the processing period being equal to P times the acquisition period, with P an integer greater than or equal to two, and
the illumination control unit (180) being arranged to determine, for each optical head (100), the light intensity of the light beam to be emitted by its illumination source at each processing time (t_{proc}), said light intensity for a given processing time being determined as a function of at least one image of the sequence of images taken by the camera of the optical head considered at an acquisition time (t_{acq}) comprised between the processing time considered and the previous processing time.

3. Spraying system according to claim 2, wherein the illumination control unit (180) is arranged to determine, for each optical head (100), the light intensity of the light beam to be emitted by its illumination source at each acquisition time (t_{acq}), said light intensity for a given acquisition time being determined as a function of at least one image of the sequence of images taken at a prior acquisition time (t_{acq}) by the camera of the optical head considered.

4. Localized spraying system according to one of the preceding claims, wherein the illumination control unit is composed of a plurality of illumination control sub-units (180), each illumination control sub-unit being integrated into an optical head (100) and being arranged to determine the light intensity of the light beam to be emitted by the illumination source of the respective optical head as a function of at least one image generated by the camera of the respective optical head.

5. Localized spraying system according to one of the preceding claims, wherein the illumination control unit (180) is arranged to determine, for each optical head (100), the light intensity of the light beam to be emitted by its illumination source, as a function of a histogram of the light intensity levels of the pixels of the image or the images considered.

6. Localized spraying system according to one of the preceding claims, wherein, in each optical head (100), the camera comprises a lens (120) arranged to capture a light stream from the plot along an optical axis (X) and a first optical sensor (130) arranged to receive the light stream and generate a first sequence of images of the plot, and the illumination source comprises a first set (160) of M light sources (161), with M being an integer greater than or equal to two, the light sources (161) being distributed around the optical axis (X) of the lens.

7. Localized spraying system according to claim 6, wherein, in each optical head (100), the first optical sensor (130) is arranged to generate the first sequence of images of the plot in one or more first acquisition spectral bands, and the first set (160) of M light sources (161) is arranged to emit a first light beam in one or more first illumination spectral bands, said one or more first illumination spectral bands covering the one or more first acquisition spectral bands.

8. Localized spraying system according to claim 7, wherein, in each optical head (100), the camera comprises a second optical sensor (140) arranged to receive the light stream captured by the lens and generate a second sequence of images of the plot in one or more second acquisition spectral bands, and the illumination source comprises a second set (170) of N light sources (171), with N an integer greater than or equal to two, the second set (170) of N light sources being arranged to emit a second light beam in one or more second illumination spectral bands, said one or more second illumination spectral bands covering the one or more second acquisition spectral bands, and the light sources (171) of the second set being distributed around the optical axis (X) of the lens.

9. Localized spraying system according to one of claims 6 to 8, wherein, in each optical head (100), the light sources (161) of the first set (160) are arranged to form a uniform illumination of the area of the plot imaged by the camera, and/or the light sources (171) of the second set (170) are arranged to form a uniform illumination of the area of the plot imaged by the camera.

10. Localized spraying system according to one of claims 6 to 9, wherein, in each optical head (100), the light sources (161) of the first set (160) are angularly distributed in a uniform manner around the optical axis (X) of the lens, and/or the light sources (171) of the second set (170) are angularly distributed in a uniform manner around the optical axis (X) of the lens.

11. Localized spraying system according to one of claims 6 to 10, wherein, in each optical head (100), the light sources (161) of the first set (160) are arranged such that each point of the area of the plot imaged by the camera receives light from at least two light sources of the first set, and/or the light sources (171) of the second set (170) are arranged so that each point in the area of the plot imaged by the camera receives light from at least two light sources of the second set.

12. Localized spraying system according to one of claims 6 to 11, wherein, in each optical head (100), each light source (161) of the first set (160) is arranged so that a main axis of its light beam is parallel to the optical axis (X) of the lens, and/or each light source (171) of the second set (170) is arranged so that a main axis of its light beam is parallel to the optical axis (X) of the lens.
